(19) United States
(12) Patent Application Publication
(10) Pub. No.: US 2005/0287340 A1
(43) Pub. Date: Dec. 29, 2005

(54) Paper napkin or similar product, printed and embossed

(75) Inventors: Alessandro Morelli, Lucca (IT); Mauro Gelli, Lucca (IT); Giovanni Nencioni, Pisa (IT)

Correspondence Address: Breiner & Breiner, L.L.C., P.O. Box 19290, Alexandria, VA, 22320-0290, US

(73) Assignee: Fabio Perini S.p.A., Lucca (IT)

(21) Appl. No.: 11/165,052

(22) Filed: Jun. 24, 2005

(30) Foreign Application Priority Data
Jun. 25, 2004 (IT) FI2004A000143

(51) Int. Cl. B32B 1/00

(52) U.S. Cl. 428/156

(57) ABSTRACT

The napkin comprises at least a first ply and a second ply joined together by gluing. At least one of the plies is embossed and a glue is applied to at least some of the embossing protuberances. A printed pattern differentiates an edge area or border (B) with respect to a central area surrounded by the edge.

### TECHNICAL FIELD

The present invention relates to a paper product, especially made of tissue paper, and in particular a folded product, such as a napkin or the like.

### PRIOR ART

Paper napkins or folded products made of tissue paper are usually formed using two or more plies joined together by gluing or knurling, i.e. ply bonding.

In the case of glued products, the glue is usually applied to the protuberances of an embossing pattern formed on the plies. In this type of article it is difficult to obtain reliable gluing up to the edges of the product, to prevent the two plies from detaching along the edge area, with consequent difficulties in packaging and the production of waste.

On the other hand, it is necessary to avoid applying too much glue, both to prevent stiffening of the product and for reasons of economy.

In napkins in which the plies are joined by knurling or ply-bonding, this is normally implemented along the edge of the product, to form a sort of border, for aesthetic and also functional reasons. The central part is, on the other hand, smooth. An example of products produced using this technique is described in WO-A-M03086743.

Processing by knurling or ply-bonding, or also by embossing, the edge area of the product causes unevenness in the thickness of the finished product, as the edge area is thicker than the central area. As the articles are folded in four and stacked, in the stack the area in which the edges of the various articles are folded and superimposed is essentially thicker than the remaining area, resulting in the formation of an irregularly shaped stack, difficult to handle and to package.

To overcome these drawbacks procedures have been studied in which the entire surface of the article is embossed and subsequently knurled or ply-bonded only along the perimeter, to obtain a product of uniform thickness. Instead, in some cases embossing is diversified between the edge and the central area. Examples of procedures of this type are described in U.S. Pat. No. 5,415,918.

While these procedures allow a decrease in drawbacks deriving from uneven thickness, they nonetheless do not solve, to a satisfactory extent, a further problem typical of paper napkins joined by ply-bonding or knurling along the border.

In fact, differentiated embossing or ply-bonding between border or edge and central area (whether it is embossed in a different way with respect to the border or simply smooth) causes considerable drawbacks deriving from the difficulty in keeping embossing patterns phased with respect to the folding and cutting lines of the paper product. In particular, this is due to the fact that embossing, knurling or other mechanical processes to permanently deform the paper ply cause elongation of the paper material which depends on the type of deformation and, at least in part, on the operating conditions, for example the humidity in the air. Therefore, as the material is deformed (embossed, ply-bonded or knurled) in a different way between the border area and the central area, the position of the border and the position of the cutting and folding lines tend to become out of phase.

On the other hand, the consumer is now used to the appearance of paper napkins characterized by the presence of the border or decorated edge, differentiated with respect to the central area.

### OBJECTS AND SUMMARY OF THE INVENTION

The object of the invention is to produce a folded paper product, composed of two or more plies joined to one another, for example a paper napkin or handkerchief, which overcomes or at least partly reduces the drawbacks of known products.

In substance, the invention provides a folded paper sheet product, comprising at least a first ply and a second ply joined to each other by gluing, wherein at least one of the plies is embossed and a glue is applied to at least some of the embossing protuberances to join the two plies, and wherein a printed pattern differentiates an edge area or border with respect to a central area of the product.

In this way embossing, which is used to glue the plies reciprocally, can be applied throughout the surface, i.e. to the entire area of the product, along areas or patterns chosen according to technical-functional and/or decorative considerations, while the printed pattern applied, for example, along the border or edge of the product (or in the central area but not on the edge) provides the conventional aesthetic effect of this type of product.

According to a particularly advantageous embodiment of the invention, a product is provided wherein a first ply has a first background embossing, comprising first protuberances with a first height, and a second decorative embossing comprising second protuberances with a second height, the second height being greater than the first height and the second protuberances projecting inside the product towards the other of the at least two plies of which the product is formed. Moreover, the glue is applied to at least some of the second protuberances.

Embossing according to two patterns of different height, and preferably of different density and dimension, can be obtained for example with a device and a procedure described in WO-A-0078533 and in WO-A-9944814.

The first background embossing (which can, for example, be formed of frusto-pyramidal or frusto-conical shaped protuberances or of other simple geometrical protuberances) provides the technical-functional characteristics of the product and no glue must be applied thereto. On the other hand, the second embossing can form a pattern throughout the surface of the finished product, i.e. which extends over the entire area of the article and not just on the edge area or border, as is the case in conventional articles. On the one hand, this makes it possible to obtain a uniform thickness of the material and on the other prevents a difference in elongation between central area and border, precluding difficulties of keeping the embossed pattern and the product cutting and folding lines in phase. Moreover, the pattern of the second embossing can be chosen so as to obtain optimal glue distribution to join the two plies, reducing glue to a minimum to avoid stiffening of the product and distributing it correctly to prevent detaching and flapping along the edges, with consequent difficulties in handling and packaging.

In particular, it would also be possible to produce, with the second series of protuberances, embossing motifs with a double height, in which the embossed pattern is composed of repetitive elements, each of which is formed of at least two protuberances of two different heights. In a per se known way, this allows the form and dimension of the embossed decorative patterns to be released from the technical-functional requirements of gluing, as better described in WO-A-03082559.

Printing combined with embossing provides the finished product with a particularly effective appearance and offers the consumer an article whose appearance is essentially the same as conventional ones, characterized by a border highlighted with respect to the central area, without the drawbacks of conventional products and, moreover, with increased aesthetic and functional advantages determined by the combined presence of double embossing, respectively technical-functional and decorative.

The glue can be colorless or colored, to combine a chromatic decorative effect with the effect obtained by printing.

Although it is preferably to provide background embossing and decorative embossing of larger dimensions and lesser density on the first ply, it would also be possible to produced one of these embossings on a first of the two plies and the other on the second ply.

When the background embossing and the decorative embossing are both produced on the first ply, the second ply of which the product is formed can be smooth or also embossed, for example with simple background embossing and, optionally, re-embossing corresponding to the decorative embossing produced on the first ply.

The protuberances which define: the background embossing can be distributed with a density of at least 15 protuberances/cm² and preferably of at least 30 protuberances/cm² and are distributed in an essentially uniform way over the entire surface area of the article.

The second protuberances can advantageously define a repetitive pattern, composed of at least one of said second protuberances, said pattern having a distribution density of no more than 2 elements/cm². They are preferably distributed on the entire surface of the product, to obtain uniform and reliable gluing, up to the edge area.

To obtain a particularly high quality product, the printed pattern preferably has a three-dimensional optical effect.

This printed pattern can be applied along the edge or border of the product, with the central area devoid of printed pattern. On the other hand, this printed pattern can be applied in the central area of the product, with the edge or border devoid of printed pattern. Alternatively, the printed pattern can be provided on the entire surface area of the product, but differentiated between border or edge and central area. However, printing along only the edge area or border is preferable to reduce the quantity of ink used.

Preferably, the printed pattern is applied to the inward facing surface of one or of the other of the outer plies. This reduces the risk of ink being released during use of the product. However, the product could also be composed of more than two plies. In this case the printed pattern can advantageously be produced on the intermediate ply or on one of the intermediate plies, when the product is composed of more than three plies.

The third ply can be smooth, although it would also be possible for it to be embossed, for example with background embossing, or it could be embossed with the same embossing pattern defined by the second protuberances described above, with glue applied to at least some of said protuberances. This is implemented in particular when specific production systems are utilized, as shall be clarified hereunder.

### BRIEF DESCRIPTION OF THE DRAWINGS

The invention shall be better understood by following the description and accompanying drawing, which shows non-limiting practical embodiments of the invention. In the particular:

FIG. 1 shows a schematic plan view of a product according to the invention in an extended arrangement;

FIG. 1A shows an enlarged detail of a portion of the printed edge area of the article in FIG. 1;

FIGS. 2 to 4 show greatly enlarged schematic local sections of a product according to the invention;

FIG. 5 shows the product in FIG. 1 folded in four;

FIG. 6 shows a product folded in four analogous to the one in FIG. 5; and

FIGS. 7, 7A and 7B schematically and partially show a portion of a line for the production of articles according to the invention.

### DETAILED DESCRIPTION OF EMBODIMENTS OF THE INVENTION

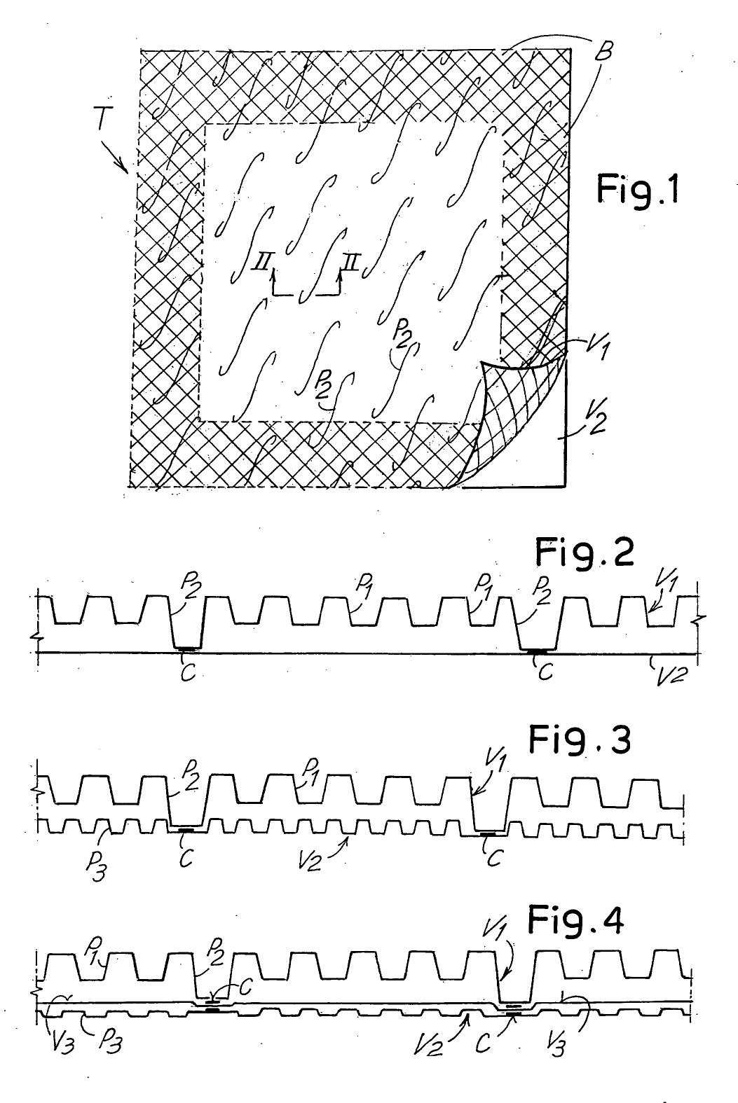

With initial reference to FIGS. 1, 1A and 2, in a first embodiment the product in the form of a paper napkin indicated generically with T, is formed of two plies or sheets V1, V2 joined to each other by gluing. The ply V1 has a first background embossing formed of a first series of protuberances P1 of reduced height and distributed with a high density, for example of around 30 protuberances per square centimeter. The protuberances P1, not represented in FIG. 1 and shown schematically in the section of FIG. 2, can be truncated pyramid shaped, with dimensions of the larger base, for example, of around 0.1-0.5 mm and with a height of 0.1-0.3 mm.

The first ply V1 also has a second decorating embossing, composed of a uniform repetition of a second series of protuberances indicated schematically with P2. In the example shown the protuberances P2 are composed of curvilinear protuberances narrow and long in shape, although this must be considered purely as an example. In fact, it must be understood that the decorative protuberances can have any shape.

What is important is solely the fact that the protuberances P2 are of a greater height with respect to the protuberances P1 and are facing, just as the latter, the inside of the product, i.e. towards the second ply. The protuberances P2 can all be of the same height, or can be of different heights, to obtain specific technical-functional effects, releasing the dimension and form of the decorative patterns with respect to the quantity of glued surface.

A glue C is applied to the top surfaces of the protuberances P2, or at least to some of said surfaces, to join the ply V1 to the ply V2. The latter is, in the example shown in FIG. 2, a smooth ply.

An edge area or border B is provided along the napkin T, bearing a printed pattern, such as a one-color pattern or a pattern with more than one color, advantageously and preferably with a three-dimensional effect decoration, i.e. which provides a sense of raised motif, for example, by means of specific positioning of the shading.

In the example in FIG. 1, printing of the edge B is produced on the inner surface of the ply V1 and is visible on the outside by transparency.

It would also be possible for printing of the edge B to be produced on the outer surface of the ply V1, although this is less suitable as internal printing prevents the leakage or accidental release of dye during use of the product. Alternatively, a food ink can be used, the leakage of which does not have drawbacks.

It would also be possible to print the ply V2 (on the outside or inside), although the printed pattern would be less visible through the principal surface of the product, i.e. the outer surface of the ply V1, on which the embossed motifs formed by the protuberances P2 are produced.

The product schematized in FIG. 1 can also have a slightly different configuration, as indicated schematically in the enlarged local section in FIG. 3. In this case the lower ply V2 is also equipped with micro-embossing formed by protuberances P3 of dimensions and form essentially similar to those of the protuberances P1.

Also in this case printing can be implemented on one or other of the surfaces of one or other of the two plies V1, V2. In both cases it would also be possible for printing to be implemented partly on one ply and partly on the other, although in some cases this may cause difficulties during phasing of the printing operations. It would be possible to produce repetitive printing on the entire surface of the ply V2 and printing along the edge or border B of the ply V1, thereby avoiding the problem of phasing one printing with the other.

FIG. 4 shows a local section of a modified embodiment of the article, in which a third ply V3 is interposed between the plies V1 and V2 embossed as in FIG. 3. The inner ply V3 can be the one on which the pattern forming the border or edge B of the finished product is printed. In the example shown the ply V3 is smooth, but it can also be embossed, for example with micro-embossing.

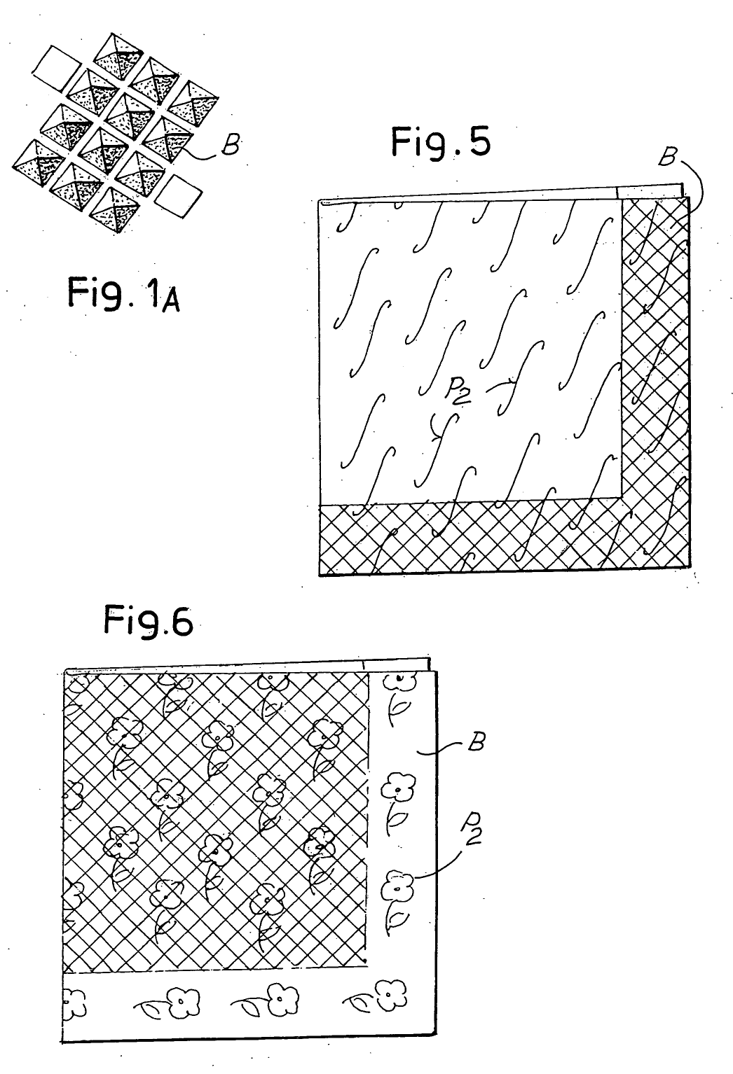

FIG. 5 shows the article T in FIG. 1 in an arrangement folded in four. Thanks to the presence of uniform embossing throughout the surface area of the article, the thickness of the folded napkin T is essentially the same throughout the entire area of the article. Nonetheless, printing of the edge B allows a decorated border effect, conventional in this type of product, to be obtained.

FIG. 6 schematically shows a variant of embodiment of the product according to the invention, in an arrangement folded in four analogous to FIG. 5. In this case the article is embossed with decorative embossing formed by composite protuberances P2, in the form of a floral decoration. The edge or border B is white or, in any case, unprinted. The printed pattern, on the other hand, is produced on the area surrounded by the edge B and, also in this case, provides a differentiation between central area and peripheral or edge area.

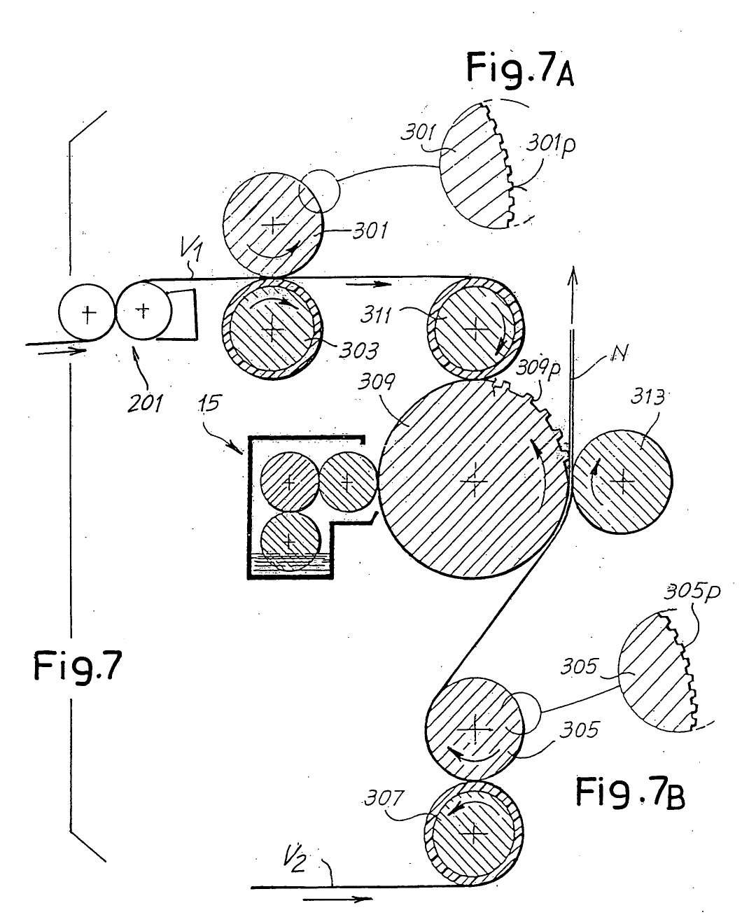

FIG. 7 shows an example of a portion of a production line of an article of the type schematized in the previous figures. Disposed downstream of the portion of line in FIG. 7 is a folding machine of a type know per se and not shown. A printing unit, which prints the edge or central area of the articles, is indicated with 201. Printing performed by this unit is in phase with subsequent folding and cutting of the continuous sheet product delivered from the device in FIG. 7, performed by the folding machine, not shown. Phasing of printing with folding and cutting is not as critical as phasing of embossing, as printing does not cause differential deformation of the ply.

The embossing roller and the pressure roller of a first micro-embossing unit, through which the ply V1 is fed, are indicated respectively with 301 and 303. The roller 301 is provided (FIG. 7A) with protuberances 301P which form the protuberances P1 on the ply V1. Downstream of the unit 301, 303 the ply V1 is driven around a pressure roller 311 of a principal embossing unit, the embossing roller 309 of which is provided with protuberances 309P which produce the protuberances P2 decorating the ply V1.

The second ply V2 is fed around the embossing roller 309 and (when it is in turn micro-embossed) is first made to pass through a second micro-embossing unit comprising an embossing roller 305 with protuberances 305P (FIG. 7B) and a pressure roller 307, coated in a yielding material analogous to the rollers 303 and 311.

A gluing unit 315 applies glue to the protuberances P2 of the ply V1 when this is still engaged with the roller 309. After applying the glue on the ply V1, this is fed, together with the ply V2, between the roller 309 and a pressure roller 313.

The system shown in FIGS. 7, 7A and 7B is essentially analogous to one of those described in WO-A-9944814, which can be referred to for greater details, with the exception of the printing unit 201.

When the article has a third ply (FIG. 4) this can be fed between the ply V1 and the ply V2 between the gluing unit 315 and the point of tangency of the ply V2 with the ply V1. The glue applied to the protuberances P2 can be sufficient to also glue the plies V2, V3, seeping through the latter in the lamination area between the roller 309 and the roller 313.

According to a possible embodiment of the invention, a modest quantity of glue can be added to the ink used for printing to improve reciprocal adhesion of the plies forming the finished product.

It is understood that the drawing merely shows an example provided purely as a practical embodiment of the invention, which may vary in forms and arrangements without however departing from the scope of the concept on which the invention is based.

1. A product in a sheet of folded paper comprising at least a first ply and a second ply joined together by gluing, wherein at least one of said first ply and said second ply is embossed and a glue is applied to at least some embossing protuberances, and wherein a printed pattern differentiates an edge area with respect to a central area surrounded by the edge area.

2. Product as claimed in claim 1, wherein:
one of said at least said first ply and said second ply has a first background embossing, comprising first protuberances with a first height, and a second decorating embossing comprising second protuberances with a second height, the second height being greater than the first height and said second protuberances projecting inside the product towards the other of said at least said first ply and said second ply;
a glue is applied to at least some of said second protuberances.

3. Product as claimed in claim 1, wherein said second ply is embossed.

4. Product as claimed in claim 2, wherein said second ply is embossed.

5. Product as claimed in claim 2 wherein said first protuberances are geometrical in shape.

6. Product as claimed in claim 5, wherein said first protuberances are distributed with a density of at least 15 protuberances/cm².

7. Product as claimed in claim 2, wherein said first protuberances are distributed in an essentially uniform way over an entire surface of the product.

8. Product as claimed in claim 2, wherein said second protuberances define a repetitive pattern, composed of elements each including at least one of said second protuberances, said pattern having a distribution density of no more than 2 elements/cm².

9. Product as claimed in claim 1 or 2, wherein said printed pattern has a three-dimensional optical effect.

10. Product as claimed in claim 1 or 2, wherein said printed pattern is applied along the edge area of the product, the central area being devoid of printed pattern.

11. Product as claimed in claim 1 or 2, wherein said printed pattern is applied in the central area of the product, the edge area being devoid of printed pattern.

12. Product as claimed in claim 1 or 2, wherein said printed pattern is applied along the edge area and in the central area of the product, printing of the edge area being different from printing of the central area.

13. Product as claimed in claim 2, wherein said first protuberances and said second protuberances are essentially distributed over an entire surface area of the product.

14. Product as claimed in claim 13, wherein said first protuberances and said second protuberances are distributed in an essentially uniform way over the entire surface area of the product.

15. Product as claimed in claim 1 or 2, wherein said printed pattern is applied to a surface facing inside of said first ply and/or of said second ply.

16. Product as claimed in claim 1 or 2, comprising at least a third ply interposed between the first ply and the second ply.

17. Product as claimed in claim 16, wherein said printed pattern is applied at least in part to said third ply.

18. Product as claimed in claim 16, wherein said third ply is smooth.

19. Product as claimed in claim 16, wherein said third ply is embossed uniformly over the entire surface.

20. Product as claimed in claim 1 or 2, wherein said glue is colored.

21. Product as claimed in claim 1 or 2, wherein said product is folded in four sections along two central folding lines.

22. Product as claimed in claim 1 or 2, wherein said product is made of tissue paper.

23. Product as claimed in claim 1 or 2, wherein said printed pattern is produced with an ink to which glue is added.
